(19) United States
(12) Patent Application Publication
(10) Pub. No.: US 2023/0266735 A1
(43) Pub. Date: Aug. 24, 2023

(54) A METHOD FOR PROCESSING ELEMENTS INTO FINAL ELEMENTS

(71) Applicant: AALBORG UNIVERSITET, Aalborg Øst (DK)

(72) Inventors: Morten KRISTIANSEN, Støvring (DK); Ewa KRISTIANSEN, Støvring (DK); Benny Ørtoft ENDELT, Dronninglund (DK); Sigurd Lazic VILLUMSEN, Harlev J (DK); Anders Noel THOMSEN, Aalborg (DK); Anders Faarbaek MIKKELSTRUP, Aalborg (DK)

(21) Appl. No.: 18/003,824

(22) PCT Filed: Jul. 2, 2021
(86) PCT No.: PCT/DK2021/050222

§ 371 Date: Dec. 29, 2022

(30) Foreign Application Priority Data
Jul. 2, 2020 (DK) PA 2020 70453

(51) Int. Cl. G05B 19/18

(52) U.S. Cl. CPC G05B 19/182; G05B 2219/37087; G05B 2219/45135

(57) ABSTRACT

The present invention relates to method for cutting and shaping and/or bending a metal element into a final element using laser means, the method comprising providing data containing a final model of the final element and providing a set of instructions as to how to process the final element from the metal element, measure the processing and provide at least a second set of instructions based on feedback, such as geometrical measurements during said processing, so as to create a final element.

### FIELD OF THE INVENTION

The present invention relates to a method and device for processing one or more elements into one or more final element from a computer model of the final element.

### BACKGROUND OF THE INVENTION

Processing of metal elements, such as sheet metal, into a final element is currently done by a performing a plurality of processes, such as laser cutting, grinding, bending, drilling, milling, polishing, engraving, marking, surface treating and forming the metal element, so as to create a final element which has undergone one or more of the above mentioned processes. When a metal element is subdued to one or more processes, the metal element is to be moved between a plurality of machines, such as a laser cutter, a milling machine and a bending machine. Having more machines in a shop requires more costs to maintain said machines and more operators, in order to have the required skills to set up and operate said machines, which further adds to costs and time consumption, to create a final element.

Furthermore, by moving an element, during processing, the tolerances of the final element can be inferior to a metal element being processed to a final element in a single machine, as a chain of tolerances build up during transfer between two or more processing machines.

Hence, an improved processing method and processing machine would be advantageous, and in particular a more efficient and/or reliable laser processing method and laser processing device would be advantageous.

### OBJECT OF THE INVENTION

It is a further object of the present invention to provide an alternative to the prior art.

In particular, it may be seen as an object of the present invention to provide a method and device for processing one or more metal elements, that solves the above mentioned problems of the prior art with using a plurality of machines for performing a plurality of processes to a metal element, in order to manufacture a final element, and instead provide a single machine to replace the plurality of processes with a laser processing method and device, which can perform all of the above processes, during a single set up of the metal element.

### SUMMARY OF THE INVENTION

Thus, the above described object and several other objects are intended to be obtained in a first aspect of the invention by providing a method for cutting and shaping and/or bending a metal element into a final element, the method comprising:
providing a metal element to be processed into a final element by cutting and shaping and/or bending,
providing laser means for cutting and shaping and/or bending the metal element, said laser means comprising at least a first laser,
providing measuring means for measuring a position of one or more sections of the metal element being cut and shaped and/or bent by said laser means,
providing controlling means for controlling the laser means, in which the controlling means can control at least a vector and velocity of said vector, an amount of energy and beam focus of said laser means,
providing data, said data comprising at least a final model of the final element and/or initial instructions as to how the metal element is to be processed into said final element by cutting and shaping and/or bending the metal element with the laser means,
providing input/output means for receiving and sending at least said data,
providing data processing means for processing the data from the input/output means to provide a first set of instructions to the controlling means, said instructions comprising at least a sequence of cutting and shaping and/or bending and further providing calculations for the vector and velocity of said vector, the amount of energy and beam focus to perform a cutting and shaping and/or bending process, by the laser means, to one or more sections of the metal element being cut and/or shaped and/or bent, and
   in which the data processing means provide at least a secondary set of instructions to the controlling means, the at least secondary set of instructions are calculated by the data processing means based on measurements provided by the measuring means, and in which the device cuts and shapes and/or bends the metal element into the final element.

The invention is particularly, but not exclusively, advantageous for obtaining a method for processing at least one metal element into one or more final elements using a single machine and thus, replacing a plurality of processing machines, such as, but not limited to, a bending or forming machine, a milling machine, a drilling machine, a grinding machine and a cutting machine. Using a single machine for performing all of the abovementioned processes saves time, is more efficient, increases the accuracy of the performed processes, reduces handling and storage of half-manufactured elements. It is to be understood that two or more final elements may be manufactured from one or more metal elements or one or more metal elements and elements from a material different from metal.

Furthermore, the invention is advantageous for forming, cutting and bending at least one metal element, so as to bend a section of the metal element towards a second section of the metal element and create a final element, e.g. a substantially square box, a rounded, donut shaped element, a rotor blade.

The invention is particularly advantageous for creating interlocked elements, such as by cutting a protruding element in a first section of the metal element, and cutting a corresponding hole in a second section of the metal element and bending the first or second section in order for the protruding element to abut to or be bent through the hole. For further interlocking the protruding element with the hole, the protruding element, when inserted through the hole, can be bent or welded on a backside of the second section of the metal element.

The metal element, according to the first aspect of the invention, may, instead, be a polymer element, a fiber element, a ceramic element or an alloy element. The final element may further be manufactured from two or more elements, such as a metal element and a polymer element, a fabric, wood or other non-laser processed elements. Furthermore, more final elements may be manufactured from one or more elements, according to the invention.

In the context of the present invention, shaping is to be understood as applying energy to a surface of a metal element so as to create or form e.g. a double curved, a convex or concave shape in said metal element, through heat expansion of said metal element. As an example, by applying energy to said element in a continuously calculated pattern, the invention can create a desired indentation or depression into a surface of said metal element. In another example, the invention can create a cone shape into or out from said metal element, by applying energy to a surface of said metal element, so as to manipulate certain sections of the surface of said metal element, through energy applied to certain points of said surface of said metal element.

In the context of the present invention, a metal element is to be understood as any element comprising metal, such as, but not limited to, iron, lead, gold, aluminum, platinum, uranium, zinc, lithium, sodium, tin, silver, copper, brass, titanium, magnesium, steel, a galvanized metal or any metal alloy. As an example, a metal element could be a block or plate of copper or a sheet metal, such as a steel sheet metal element.

In the context of the present invention, cutting is to be understood as cutting into a surface so as to create a surface groove or cutting through a surface and creating a through-going groove or cutting a metal element into a plurality of metal elements. As an example, laser ablation can be used to create a hole in a surface, which resembles the hole of a manual drilling process.

In the context of the present invention, bending is to be understood as bending a section of the metal element at an angle, relative to an adjacent section of said metal element, such as by bending a sheet metal into a 90 degrees angle.

In the context of the present invention, processing is to be understood as an operation or treatment performed to the element, such as a metal element, so as to manufacture or create an element different from the non-processed element, e.g. surface treating, color treatment, case-hardening, shaping, bending, forming, cutting or welding said metal element.

This embodiment of the invention is particularly advantageous for creating a wear-resistant or weather-resistant surface of a final element, after a shaping, bending, forming or welding process.

In the context of the present invention, laser means is to be understood as means for generating a beam of coherent electromagnetic radiation usually in the ultraviolet, visible, or infrared regions of the spectrum, such as, but not limited to a fiber laser, a CO2 laser, pulsed-rod laser, a solid-state laser, a disc laser, a diode laser or a UV laser or a combination of one or more of the mentioned laser types, such as laser means comprising a CO2 laser and a fiber laser. A laser comprises an energy source which is directed from the laser to a point of interest and in the context of the present invention, a vector is to be understood as the direction from which the laser origins, to a point at which the laser interacts with the metal element, which defines a directed line segment between the laser and the metal element.

In another embodiment of the invention, the device may further comprise a combination of laser means and another source of energy, such as an electron beam.

In the context of the present invention, beam focus is to be understood as the width and shape of the laser beam at the point of interaction with the metal element, such as, but not limited to a circular beam with a diameter of between 10.00 cm and 0.0005 cm, more preferably between 5.00 cm and 0.005 cm and most preferably between 3.00 cm and 0.01 cm. Other beam shapes may be, but not limited to oval, square or any tailored beam patterns consisting of one or more tailored beam patterns of one or more spots.

In the context of the present invention, measuring means is to be understood as means for measuring one or more geometries, densities and features of the metal element, e.g. a line scanner, a 3D scanner or 3D measuring device, an ultrasound device, stereo vision, an X-ray device, time of flight, a scattered light/structured light sensor, a 2D scanner, 1D scanner/point sensor, a CCD sensor system or a tactile measuring system.

In the context of the present invention, controlling means is to be understood as a device or mechanism used to regulate or guide the operation and/or connection to a peripheral device, such as, but not limited to, the laser means and the measuring means, the controlling means being e.g. a computer, a chip, or a circuit.

In the context of the present invention, data is to be understood as a list of instructions or file containing technical drawings, such as a CAD file of an element, to be interpreted by a computer or a combination of supplied data and measurement data obtained by measuring a prototype or from data supplied from a database.

In the context of the present invention, input/output means is to be understood as a computer, processing system or device arranged to send and receive information from or to a data processing system or computer, such as a wireless receiver/transmitter or a physical data port.

In an embodiment of the invention, the input means may be a screen associated with the device, enabling an operator to directly input instructions, as to how the device is to process the metal element into the final model.

In another embodiment of the invention, the input means may be a USB port or other data port, for receiving data from a device containing data.

In the context of the present invention, a sequence is to be understood as a continuous or connected series of processes. As an example, a sequence may comprise a cutting process, a bending process and a welding process in that order.

In the context of the present invention, data processing means is to be understood as a computer, a chip or a circuit being arranged for calculating and/or interpreting data from a peripheral device, such as calculating a defined energy to be applied by a fiber laser to a metal element to perform a desired action, such as cutting and, optionally, recalculating said applied energy through a feedback loop, from the measuring means, a temperature sensor, a distance sensor, a light sensor, an absorption sensor, a radiation sensor, such as a passive or active infrared sensor or other sensor.

In an embodiment of the present invention, the data processing means provide continuous instructions, based on a first set of instruction and a plurality of subsequent sets of instructions, said plurality of subsequent instructions being based on one or more inputs from e.g. the measuring means. This embodiment is particularly advantageous for providing accurate laser processing through accurate information relating to the current geometry, of any sections of the metal element, being processed.

In an embodiment of the invention, the method further comprises welding means controlled by the controlling means and the at least first and second set of instructions further comprise instructions as to how the controlling means controls said welding means, in which the embodiment is arranged to weld two or more sections of the metal element together.

This embodiment of the invention is particularly advantageous for interlocking two or more sections of the metal element together by welding, such as welding along or in a point, between two abutting edges of said two sections of the metal element.

In another embodiment of the invention, the method further comprises laser means according to the first aspect of the invention, in which the laser means comprises welding means.

This embodiment of the invention is particularly advantageous for using a method of creating a final element, in which the laser means performs all of the processing means, so as to increase the accuracy of said performed processes.

In another embodiment of the invention, the method further comprises fixation means for fixating at least a first section of the metal element, said fixation means being controlled by the controlling means, and in which the fixation means fixate at least a first section of the metal element during the cutting and shaping and/or bending and/or welding process.

This embodiment is advantageous for fixating elements, which may move during the processing and hence, reduce the accuracy of said processes.

In a preferred embodiment of the invention, the method further comprises dynamic fixation means being controlled by the controlling means and the at least first and second set of instructions further comprise instructions as to how the controlling means controls said dynamic fixation means, and wherein the method according to the first aspect further comprises fixating the metal element at various sections during the cutting and shaping and/or bending and/or welding process. The dynamic fixation means may comprise a robotic gripper, or other suitable robotic mechanism.

This embodiment is particularly advantageous for moving the element during processing, so as to enable the laser processing means to have access to additional angles of the metal element during processing. As an example, the metal element can be processed on one or more sections and surfaces, which have been facing away from the laser means, such as towards a bench or table, during initial processing.

In another embodiment of the invention, the method further comprises a conveyor belt, said conveyor belt being controlled by the controlling means, the method further comprising transporting one or more metal element into a processing cell for processing the metal element into the final element, and optionally transporting the final element out from the processing cell.

This embodiment is particularly advantageous for processing a plurality of elements, which are fed through a laser cell, so as to mass-produce a type of final element, saving time and reducing cost of the final elements. In other embodiments of the invention the transport mechanism for transporting an element into the processing cell may be a set of rollers, carts, wagons or coasters, suitable for transporting elements along a predetermined path.

In another embodiment of the invention, the method further comprises automatic positioning means being controlled by the controlling means for positioning the metal element in the fixation means and the at least first and second set of instructions further comprise instructions as to how the controlling means controls said automatic positioning means, and wherein said metal element is repositioned in the fixation means during the cutting and shaping and/or bending and/or welding of said metal element.

This embodiment is particularly advantageous for creating complex final elements, which otherwise would provide shadowing of one or more sections of the metal element relative to the vector of the laser means. By adjusting the metal element with the automatic positioning means, the laser means has better access to a plurality of section of the metal element. As an example, the automatic positioning means may be a robotic arm with a gripping device, for gripping the metal element.

In another embodiment of the invention, the method further comprises a temperature sensor, wherein said temperature sensor provides at least a first temperature measurement of a section of the metal element to the data processing means for calculating said at least first and second set of instructions. This embodiment is advantageous for quality assurance and control, so as to ensure that the metal element is not overheated during processing, which may alter the surface, elastic and strength properties of the metal element and prevent unwanted geometries in the element, such as buckling. In another embodiment of the inventions, the sensor may be a sensor suitable for measuring radiation, such as an infrared sensor or camera.

In the context of the present invention, buckling is to be understood as buckling is the sudden change in shape of a structural component during processing, such as during shaping/forming or bending.

In an advantageous embodiment of the invention, the method further comprises providing a gas exhaust being controlled by the controlling means and the at least first and second set of instructions further comprise instructions as to how the controlling means controls said gas exhaust, and the method further comprises providing gas to a section of the metal element being cut and shaped and/or bent and/or welded.

This embodiment is advantageous for ensuring quality assurance, in which the provided gas ensures improved cutting, forming and welding of the metal element and further provides oxidative protection to the element.

This embodiment may further be advantageous for correcting the temperature of the point of processing, by adjusting flow and temperature of the gas supplied. In another advantageous embodiment, the data relating to the gas may be provided to the processing means for further optimizing the cutting, bending, shaping/forming and welding processes.

In another embodiment of the invention, the method further comprises cutting at least a first and second section in the metal element, cutting at least a first hole in the first section of the metal element, cutting and/or shaping the second section of the metal element to form at least a first protruding element of said second section of the metal element, shaping and/or bending the first or second section of the metal element to join or insert the first protruding element into or through said first hole.

This embodiment of the invention is advantageous for planning and designing interlocking sections of the metal element, so as to improve the stability and rigidity of the final model.

In an advantageous embodiment of the invention, the method further comprises shaping and/or bending and/or welding the at least first protruding element to interlock with the at least first hole.

This embodiment of the invention is advantageous for planning and designing interlocking sections of the metal element, so as to improve the stability and rigidity of the final model.

In an embodiment of the invention, the metal element is a sheet metal, a metal plate, a metal foil, a slab or block of metal or a metal tube.

In an advantageous embodiment of the invention, the method further comprises providing a second element to be processed with the metal element, providing one or more fixation means, and wherein the metal element and the second element are positioned in the fixation means or the first metal element is positioned in a first fixation means and the second element are positioned in a second fixation means and the laser means process the metal element and the second element into the final element.

This embodiment of the invention is advantageous for processing two or more metal elements to be processed, so as to create more complex final models. In an example of the embodiment, the second element is a polymer, such as, but not limited to PTFA, which is adjoined with the metal element. In another example of the embodiment of the invention, the second element is a second metal element, the metal of the second metal element being different from the metal of the first metal element.

In another advantageous embodiment of the invention, the method further comprises providing induction means, said induction means being controlled by the controlling means, and preheating at least a section of the metal element with the induction means before or during the processing of the metal element into the final element.

This embodiment is advantageous for saving time during the processing of the metal element.

In yet another advantageous embodiment of the invention, the method further comprises
providing surface analysis means, said surface analysis means being configured for measuring backscatter from one or more surfaces of the metal element.

In the context of the present invention, backscatter is to be understood as any deviation from expected light being reflected back in the direction from which it came, such as an expected reflection from a metal surface and wherein said backscatter may be converted into a map of the surface, said map comprising reflective information relating to all relevant areas of said surface. In other embodiments, the surface may comprise one or more of ceramics, paint or coatings, natural materials, such as wood or paper.

In an embodiment, a laser scanner may be used to measure the backscatter intensity from the laser line. As colors are a representation of the light, that is reflected from the surface in a given wavelength. The reflected wavelengths may be used to obtain an indication of the color of the scanned surface. However, in this case, the purpose is not to obtain the color of the surface, but to locally estimate the amount of absorbed and reflected light from the surface. The result can be represented as an image or map of the scanned surface, where the greyscale pixel intensities in an image corresponds to the amount of absorbed and reflected light. The shinier the surface, the more light is reflected and the brighter the surface will appear in the image.

When analyzing the surface, the wavelength of the laser light, used for scanning, should be close to the same wavelength as the laser used for processing, due to some surfaces reflecting different wavelengths of light. The same applies for the angle at which the laser is projected and subsequently captured on the surface, as this will also influence the result.

This embodiment of the invention, is particularly advantageous for analyzing the surfaces of the metal element, so as to correct or adjust for any surface defects or any contaminations, so as to ensure that the energy from the laser device, intended for processing said metal element is not scattered or reflected from the surface, and hence create instructions and/or process steps which correct for said surface defects or contaminations.

In the context of the present invention, defects or surface defects is to be understood as, but not limited to dents, scratches, protrusions, notches, cracks, cuts, wear, corrosion, etching, tarnish, fading, peel off or flake off and crevices or other not desired damages to the surface.

In the context of the present invention, contaminations is to be understood as, but not limited to oil, grease, hairs, dust, dirt, extraction, spillage, soot, moisture, process remains or other polluting particles present on a surface or impurities within said surface.

In a further embodiment, the surface analysis can be combined with a geometrical analysis of the metal element, such as a 2-D or 3-D geometrical analysis.

In yet another embodiment, the surface analysis may be used to preprocess any surfaces which may have defects or contamination.

The measuring means and the surface analysis means may be a single device, configured to provide geometrical data and surface data relating to the metal element and providing said data for processing of the metal element by using the laser supplied from the laser means intended for processing of the (metal) element, wherein the surface analysis is performed by using low power level settings on said laser means and a sensor for measuring the reflected backscatter.

In a second aspect, the present invention relates to a device for cutting and shaping and/or bending a metal element into a final element, the device comprising:
laser means for cutting and shaping and/or bending the metal element,
measuring means for measuring a position of one or more sections of the metal element being cut and shaped and/or bent by said laser means,
controlling means for controlling the laser means, in which the controlling means can control at least a vector and velocity of said vector, an amount of energy and beam focus of said laser means,
input/output means for receiving and sending data, the data comprising at least a final model as to how the metal element is to be processed into the final element by cutting and shaping and/or bending, by the laser means,
data processing means for processing the data from the input/output means and in which the data processing means further calculate at least a first set of instructions to the controlling means, said first set of instructions comprising at least a sequence of cutting and shaping and/or welding and further comprises calculations for the vector and velocity of said vector, the amount of energy and beam focus, to perform a cutting and shaping and/or bending process, by the laser means, to one or more sections of the metal element being cut and/or shaped and/or bent, and
   in which the data processing means provide at least a secondary set of instructions to the controlling means, the at least secondary set of instructions are calculated by the data processing means based on measurements provided by the measuring means, and in which the device cuts and shapes and/or bends the metal element into the final element.

The device may especially be a laser processing device which is adapted for carrying out the method as set forth in the first aspect of the invention, such as to process a metal coil, a sheet metal or a block of metal into a final model, such as a complex final model which requires a plurality of processes to be finalized. This embodiment is advantageous for reducing the floor space required and time consumed and further to increase the accuracy of said processes, by completing all of said processes within a single device.

In a third aspect, the invention relates to a computer program for calculating at least a first set of instructions to the device according to the second aspect of the invention, when being executed by a data processor, in which the invention is adapted for controlling and/or for carrying out the method as set forth in the first aspect of the invention.

This embodiment is advantageous for providing a computer program product, which may be adapted to an existing laser processing device, so as to increase the processing features of said existing laser device.

In a fourth aspect, the invention relates to the use of a device according to the second aspect of the invention, for processing a metal element into a final element using any of the method disclosed in the first aspect of the invention.

The first, second, third and fourth aspect of the present invention may each be combined with any of the other aspects. These and other aspects of the invention will be apparent from and elucidated with reference to the embodiments described hereinafter.

### BRIEF DESCRIPTION OF THE FIGURES

The method for cutting and shaping and/or bending a metal element, and a device for completing said method, according to the invention will now be described in more detail with regard to the accompanying figures. The figures show one way of implementing the present invention and is not to be construed as being limiting to other possible embodiments falling within the scope of the attached claim set.

FIG. 1 is a trimetric view of a laser processing method, according an embodiment of the invention.

FIG. 2 is a trimetric view of a second laser processing method, according to an embodiment of the invention.

FIG. 3 is a section view of two different interlocking methods, according to an embodiment of the present invention.

FIG. 4 is a trimetric view of another laser processing method, according to an embodiment of the invention.

FIG. 5 is a section view of a third interlocking method, according to an embodiment of the present invention.

FIG. 6 is a top view of various examples of fixation structures cut from an element, according to an embodiment of the invention.

FIG. 7 is a surface analysis representation, according to an embodiment of the invention.

FIG. 8 is a flow-chart of a method embodiment, according to the invention.

### DETAILED DESCRIPTION OF AN EMBODIMENT

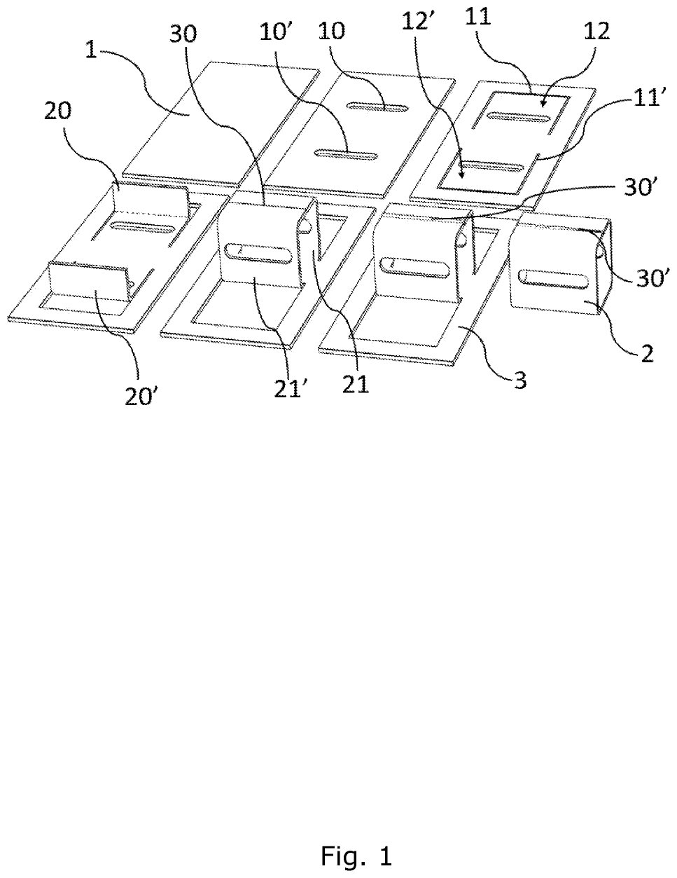

FIG. 1 is a trimetric view of a laser processing method, according to an embodiment of the invention. Figure illustrates, from left top to right bottom, the process of manufacturing a final element 2, from a metal element 1. The final element 2 is manufactured by initially cutting two identical holes 10, 10′ in the metal element 1. Then two outlines 11, 11′ is cut around the two holes 10, 10′, creating two identical sections 12, 12′. A first part 20 of the first section 12 and a first part 20′ of the second section 12′ is bend upwards, from the plane of the metal element 1. Then, a second part 21 of the first section 12 and a second part 21′ of the second section 12′ is bend upwards, from the plane of the metal element 1, enabling the first part 20 of the first section 12 and the first part 20′ of the second section 12′ to abut, creating a gap line 30 between the two parts 20, 20′. Then the gap line 30 is welded, interlocking the first section 12 and the second section 12′, after which the final element 2 is cut from the non-processes section 3 of the metal element 1, to finalize the final element 2, wherein the two sections 12, 12′ are fixated by a weld 30′, creating a rigid three-dimensional structure from the two-dimensional metal element 1.

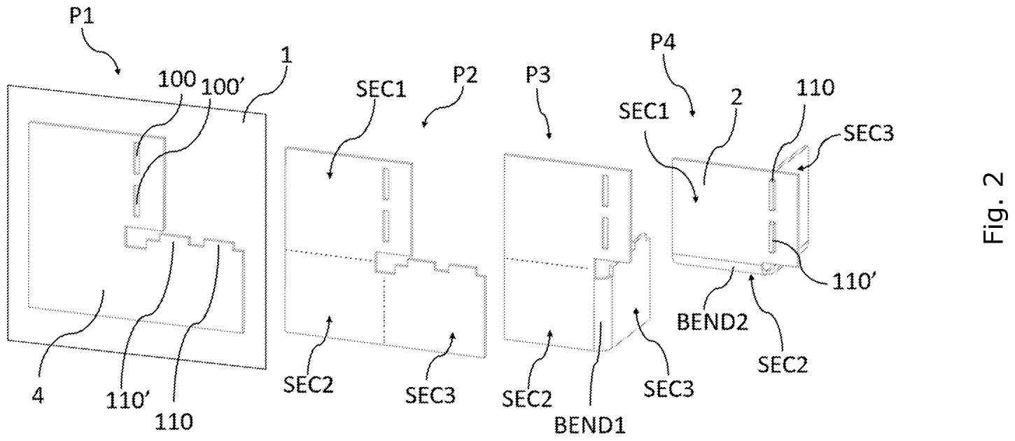

FIG. 2 is a trimetric view of a second laser processing method, according to an embodiment of the invention. The figure illustrates, four processing steps P1, P2, P3 and P4. The first process step P1 illustrates a cut-out 4 of a metal element 1, the cut-out 4 having a first and second cut hole 100, 100′ and two protruding elements 110, 110′. In the second process step P2, the figure further illustrates three sections SEC1, SEC2 and SEC3 of the cut-out 4. To form a final element 2, the third process step P3 illustrates that SEC3 is bend BEND1 relative to SEC 1 and SEC2, forming an element wherein SEC 3 has a plane perpendicular or substantially perpendicular to a plane of SEC1 and SEC2. In the fourth process step P4, SEC 2 is bend BEND2 relative to SEC1, forming the final element 2, wherein the plane of SEC2 is perpendicular or substantially perpendicular to the plane of SEC1, SEC3 abuts a surface of SEC 1 and the protruding elements 110, 110′ are protruding from the holes 100, 100′, respectively, so as to interlock SEC3 to SEC1. In an embodiment of the invention, further laser cutting, laser bending or laser welding processes can be performed on the final element.

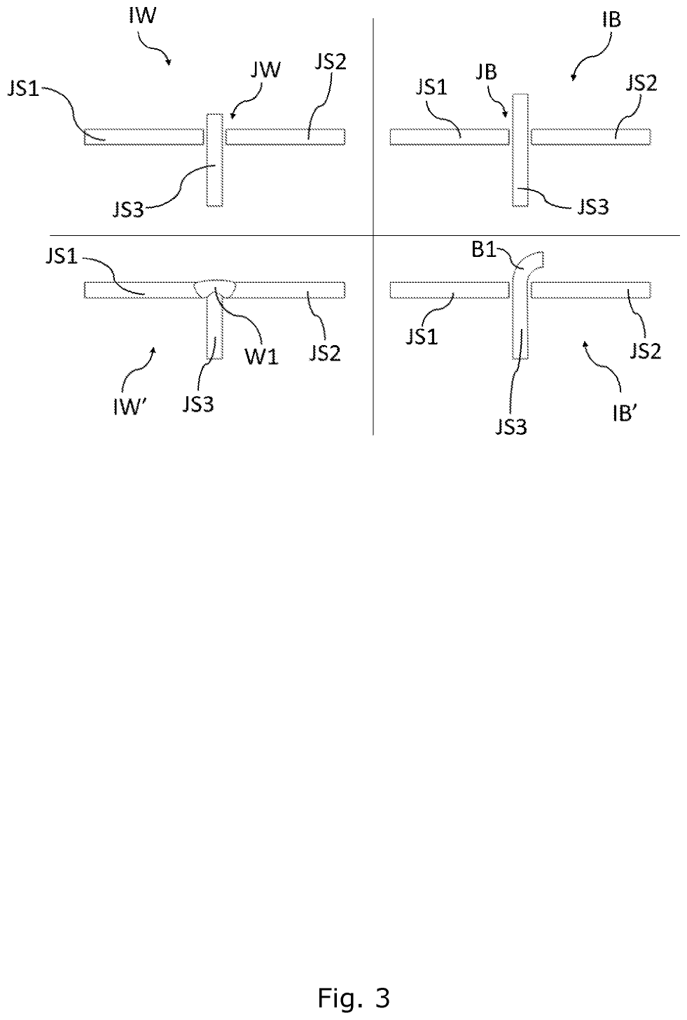

FIG. 3 is a section view of two different interlocking methods, according to an embodiment of the invention. The figure illustrates two different methods IW, IB for interlocking three joint sections JS1, JS2 and JS3. The interlocking method for welding IW illustrates three sections, JS1, JS2 and JS3, wherein JS1 and JS2 are fixated (not shown) and JS3 protrudes in a gap suitable for laser welding JW, between the two joint sections JS1, JS2. In IW′ the three joint sections JS1, JS2 and JS3 has been laser welded W1 together so as to interlock the three joint sections JS1, JS2 and JS3. The interlocking method for bending IB illustrates three sections, JS1, JS2 and JS3, wherein JS1 and JS2 are fixated (not shown) and JS3 protrudes in a gap JB suitable for laser bending, between the two joint sections JS1, JS2. In IB′, JS3 has been bend B1 together, so as to interlock the three joint sections JS1, JS2 and JS3.

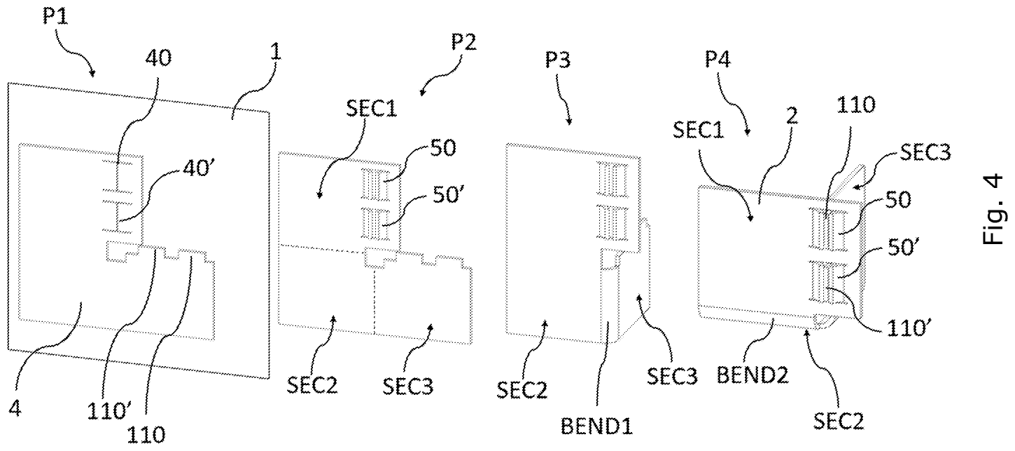

FIG. 4 is a trimetric view of another laser processing method, according to an embodiment of the invention. The figure illustrates, four processing steps P1, P2, P3 and P4. The first process step P1 illustrates a cut-out 4 of a metal element 1, the cut-out 4 having a first and second laser cut pattern 40, 40′ and two protruding elements 110, 110′. In the second process step P2, the figure further illustrates three sections SEC1, SEC2 and SEC3 of the cut-out 4 and two wing-shaped holes 50, 50′ formed from the two laser cut patterns 40, 40′. To form a final element 2, the third process step P3 illustrates that SEC3 is bend BEND1 relative to SEC 1 and SEC2, forming an element wherein SEC 3 has a plane perpendicular or substantially perpendicular to a plane of SEC1 and SEC2. In the fourth process step P4, SEC 2 is bend BEND2 relative to SEC1, forming the final element 2, wherein the plane of SEC2 is perpendicular or substantially perpendicular to the plane of SEC1, SEC3 abuts a surface of SEC 1 and the protruding elements 110, 110′ are protruding from the wing-shaped holes 50 and 50′, respectively, so as to interlock SEC3 to SEC1. In an embodiment of the invention, further laser cutting, laser bending or laser welding processes can be performed on the final element.

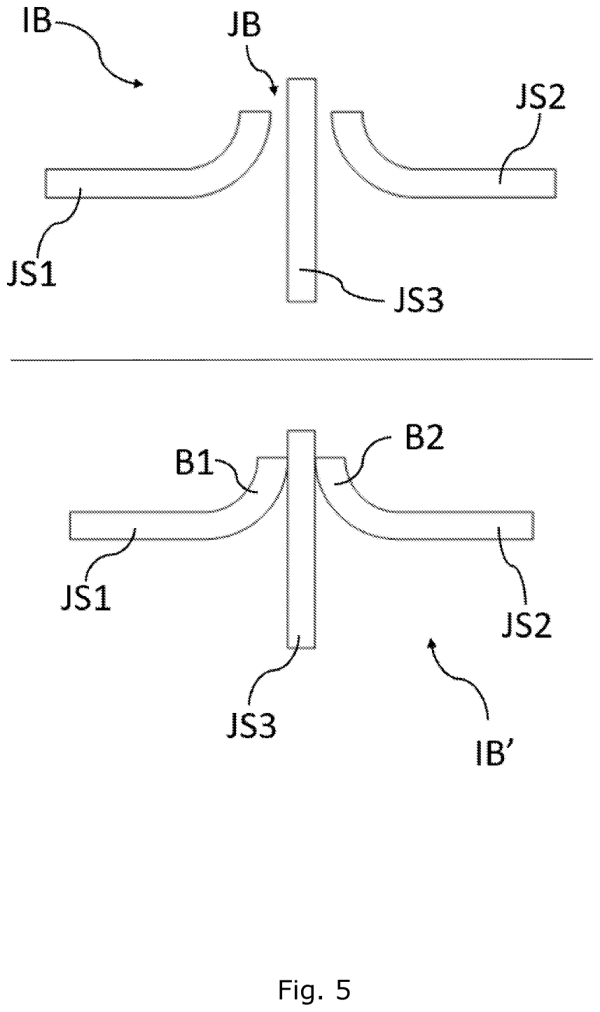

FIG. 5 is a section view of a third interlocking method, according to an embodiment of the present invention. The interlocking method for bending IB illustrates three sections, JS1, JS2 and JS3, wherein JS1, JS2 or JS3 are fixated (not shown) and JS3 protrudes in a gap JB suitable for laser bending, between the two joint sections JS1, JS2. In IB′, JS1 and JS2 have been bend B1, B2, abutting JS1 and JS2 to a portion of JS3, so as to interlock the three joint sections JS1, JS2 and JS3.

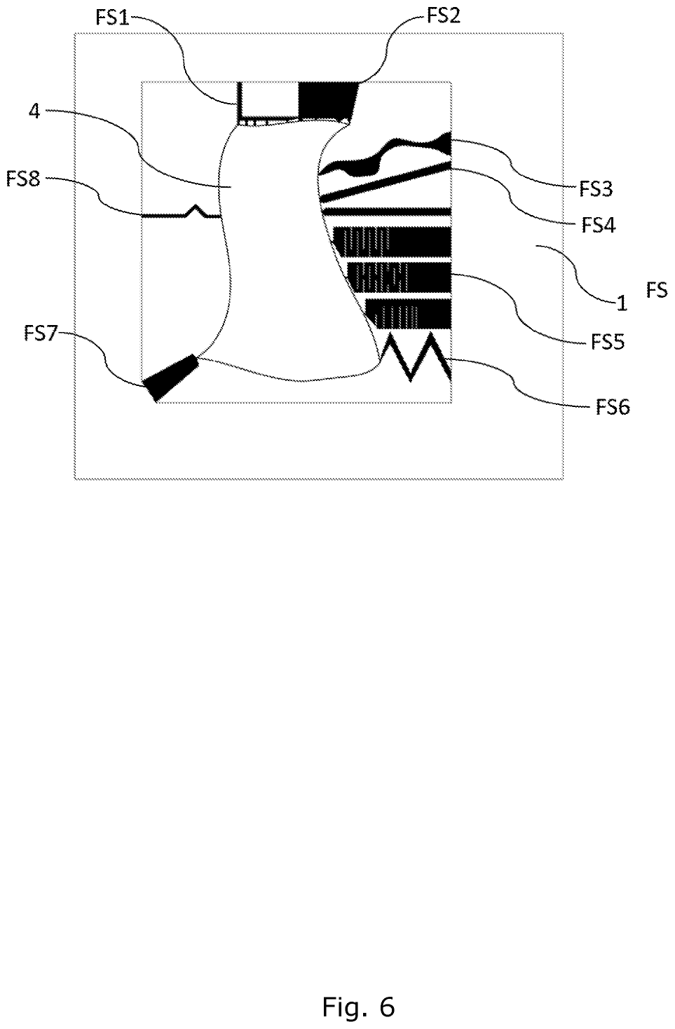

FIG. 6 is a top view of various examples of fixation structures cut from an element, according to an embodiment of the invention. The figure illustrates a metal element with a cut-out 4 and a plurality of fixation structures FS, cut from the metal element 1, so as to fixate the cut-out 4 to the metal element 1 during any further processes (not shown) performed to the cut-out 4.

In the context of the present invention, it is to be understood that simple and flexible strategies for constraining the part during forming is crucial for the laser forming process i.e. a stable position in space is mandatory for the process to work however, over constraining the part will hinder the desired deformation of the part. This problem is addressed by introducing flexible constraint elements FS3, FS6, FS8 i.e. stiff elements FS1, FS2, FS4, FS7, extendable elements FS5 etc. these elements are realised using the base material. The flexible elements can be designed for suppressing undesired deformation modes e.g. torsion, or alternatively allowing a desired deformation mode e.g. in-plane draw-in. This allows the part to form in the desired way and the position and stability of the part is kept, in order to have a stable fixation for the laser processing. The fixation points can if necessary gradually be disconnected by laser cutting, in order for the parts to form in the desired way. At the end of processing, the flexible structures may be disconnected from the fixture. Advanced fixation structures can also be applied, where more degrees of freedom are released gradually during forming/manufacturing of the final element from the metal element.

In another embodiment of the invention, the metal element may be an element from another material than metal, such as a polymer.

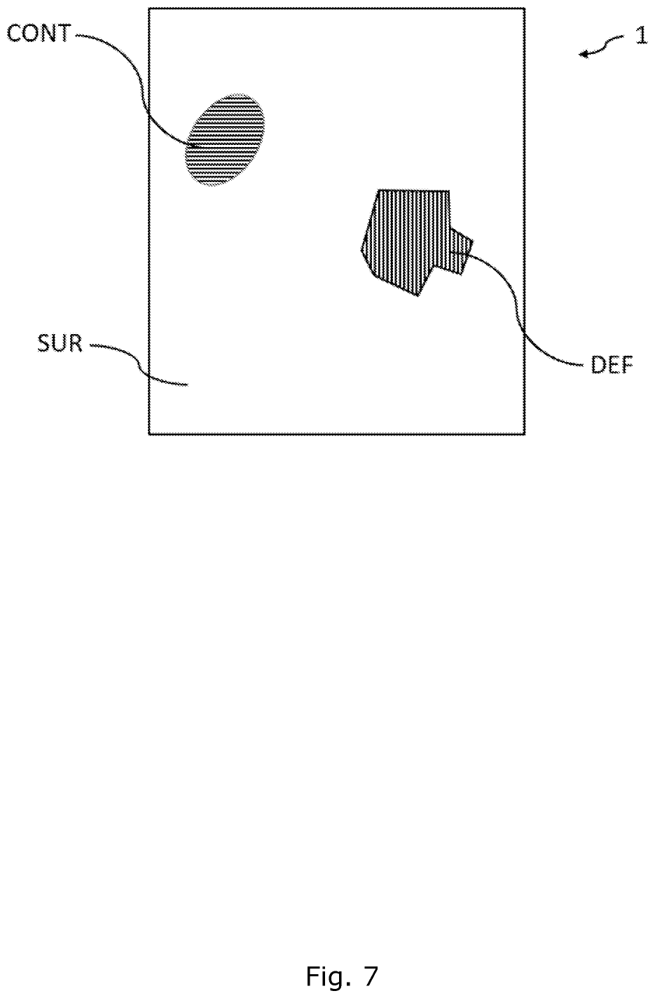

FIG. 7 shows a metal element 1 being analyzed for any surface defects or contamination. The figure shows a square, flat metal element 1 wherein the surface has been analyzed for backscatter intensity, and wherein said surface has a first area SUR which has a uniform backscatter, a second area DEF which has a defect, such as scratch and a third area CONT which has been contaminated by a fingerprint.

In an embodiment of the invention, the method corrects for said detected surface defects DEF and contaminations CONT, by adjusting the energy level for the laser device/means on said affected areas DEF, CONT, so as to attain the desired process of the metal element 1 in spite of said defect and/or contaminated areas DEF, CONT.

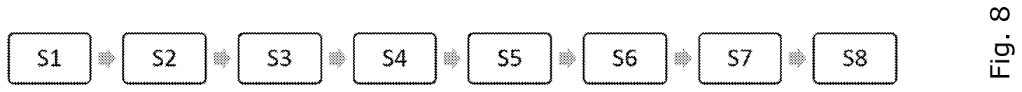

FIG. 8 is a flow-chart of a method embodiment, according to the invention. The flow-chart is a method embodiment for manufacturing a final element from a metal element, using a plurality of laser processes, the method comprising:
S1—providing a metal element to be processed into a final element by cutting and shaping and/or bending,
S2—providing laser means for cutting and shaping and/or bending the metal element, said laser means comprising at least a first laser,
S3—providing measuring means for measuring a position of one or more sections of the metal element being cut and shaped and/or bent by said laser means,
S4—providing controlling means for controlling the laser means, in which the controlling means can control at least a vector and velocity of said vector, an amount of energy and beam focus of said laser means,
S5—providing data, said data comprising at least a final model of the final element and/or initial instructions as to how the metal element is to be processed into said final element by cutting and shaping and/or bending the metal element with the laser means,
S6—providing input/output means for receiving and sending at least said data,
S7—providing data processing means for processing the data from the input/output means to provide a first set of instructions to the controlling means, said instructions comprising at least a sequence of cutting and shaping and/or bending and further providing calculations for the vector and velocity of said vector, the amount of energy and beam focus to perform a cutting and shaping and/or bending process, by the laser means, to one or more sections of the metal element being cut and/or shaped and/or bent, and
S8—in which the data processing means provide at least a secondary set of instructions to the controlling means, the at least secondary set of instructions are calculated by the data processing means based on measurements provided by the measuring means, and in which the device cuts and shapes and/or bends the metal element into the final element.

It is to be understood that continuous or intermittent subsequent sets of instructions can be created by repeating S3, S5 and S7 after performing S8 (a feedback loop).

In an embodiment of the invention, one or more laser processes can be carried out in the same unit to process sheet metal into a product/given component, said laser processes being: laser cutting (remote and/or gas assisted), laser forming/bending (laser induced bending/shaping), such as linear sharp and soft bends and doubly curved three dimensional bends, and laser welding.

With a combination of these processes, 3D structures in the form of a product/given component can be created directly from flat sheet metal. As an example: A piece of sheet metal is inserted into the machine. The piece is laser cut with gas assisted cutting to maximize speed and quality. Afterwards the piece is laser formed/bended, laser welded and laser cut remote and/or gas assisted in a defined sequence in order to shape the desired geometry. I order to achieve the geometry a number of measurement tasks are used to keep the tolerances.

By utilizing a combined laser system the desired processing can be done without any additional tooling or fixtures, and at a high pace with high surface quality, which decreases costs of creating a large variety of components from sheet metal, such as casings, mounting structures, blades, medical parts, component for architect designed buildings, prototypes, small batch sizes parts etc.

Another advantage of this invented system is the prospect of retrofitting existing laser systems with the technology, increasing the area of usage of an expensive machine.

In an advantageous embodiment of the invention, the feedback control of the laser forming process relates to continuous monitoring of the laser forming processes for deviations from the desired part geometry and handling of the possible errors by automatic adjustment of the initial plan of combined laser processing.

The control strategy is based on a feedback system where heat input trajectories are calculated based on either strain fields or curvature. The strain field or curvature is updated a number of times during the forming operation, by scanning the part and calculate a strain field or curvature mapping the current geometry to the final geometry.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method for cutting and at least one of shaping, welding and bending a metal element into a final element, the method comprising:
providing a metal element to be processed into a final element by cutting and at least one of shaping, welding and bending the metal element,
providing a laser configured to cut and at least one of shape, weld and bend the metal element, the laser comprising at least a first laser source,
providing a measuring device configured to measure a position of one or more sections of the metal element being cut and at least one of shaped, welded and bent by the laser,
providing a control configured to controlling the laser, wherein the controller is enabled to control at least a vector and velocity of the vector, an amount of energy and beam focus of the laser,
providing data, the data comprising at least one of a final model of the final element and initial instructions as to how the metal element is to be processed into the final element by cutting and at least one of shaping, welding and bending the metal element with the laser,
providing an input/output device configured to receive and send at least the data,
providing a data processor configured to process the data from the input/output device to provide a first set of instructions to the controller, the instructions comprising at least a sequence of cutting and at least one of shaping, welding and bending and further providing calculations for the vector and velocity of the vector, the amount of energy and beam focus to perform a cutting process and at least one of a shaping, welding and bending process, by the laser, to one or more sections of the metal element being at least one of cut, shaped, welded and bent, and
in which the data processor provide at least a secondary set of instructions to the controller, wherein the at least secondary set of instructions are calculated by the data processor based on measurements provided by the measuring device, and in which the laser cuts and at least one of shapes, welds and bends the metal element into the final element.

2-16. (canceled)

17. The method according to claim 1, further comprising:
providing a fixation mechanism configured to fixate at least a first section of the metal element, the fixation mechanism being controlled by the controller, and
fixating at least a first section of the metal element during the cutting process and at least one of the shaping, bending and welding process.

18. The method according to claim 1, further comprising:
providing a fixation mechanism, wherein the fixation mechanism is adapted as a dynamic fixation device being controlled by the controller and the at least first and the secondary set of instructions further comprise instructions as to how the controller controls the dynamic fixation device, and
fixating the metal element at various sections during the cutting process and at least one of the shaping, bending and welding process.

19. The method according to claim 1, the method further comprising:
providing a conveyor belt, the conveyor belt being controlled by the controller,
transporting one or more metal element(s) into a processing cell for processing the metal element into the final element, and
transporting the final element out from the processing cell.

20. The method according to claim 1, the method further comprising:
providing an automatic positioning mechanism being controlled by the controller and providing a fixation mechanism, the automatic positioning mechanism being adapted to position the metal element in the fixation mechanism and the at least first and second set of instructions further comprise instructions as to how the controller controls the automatic positioning mechanism, and
repositioning the metal element in the fixation mechanism during cutting and at least one of the shaping, bending and welding of the metal element.

21. The method according to claim 1, the method further comprising:
providing a temperature sensor,
providing at least a first temperature measurement of a section of the metal element to the data processor for calculating the at least first and second set of instructions.

22. The method according to claim 1, the method further comprising:
providing a gas exhaust being controlled by the controller and the at least first and second set of instructions further comprise instructions as to how the controller controls the gas exhaust, and
providing gas to a section of the metal element being cut and at least one of shaped, bent and welded.

23. The method according to claim 1, the method further comprising:
cutting at least a first and second section in the metal element,
cutting at least a first hole in the first section of the metal element,
performing at least one of cutting and shaping of the second section of the metal element to form at least a first protruding element of the second section of the metal element,
performing at least one of shaping and bending the first or second section of the metal element to join or insert the first protruding element into or through the first hole.

24. The method according to claim 1 further comprising:
cutting at least a first and second section in the metal element,
cutting at least a first hole in the first section of the metal element,
performing at least one of cutting and shaping of the second section of the metal element to form at least a first protruding element of the second section of the metal element,
performing at least one of shaping and bending the first or second section of the metal element to join or insert the first protruding element into or through the at least first hole.
welding the at least first protruding element to interlock with the at least first hole.

25. The method according to claim 1, the method further comprising:
providing a second element to be processed with the metal element
providing one or more fixation mechanisms, and
the metal element and the second element are positioned in the fixation mechanism, or the first metal element is positioned in a first fixation mechanism and the second element are positioned in a second fixation mechanism, and the laser process the metal element and the second element into the final element.

26. The method according to claim 1 further comprising:
providing an induction coil, the induction coil being controlled by the controller, and
preheating at least a section of the metal element with the induction coil prior to or during the processing of the metal element into the final element by the laser.

27. The method according to claim 1, the method further comprising
providing a surface analysis device, the surface analysis device being adapted to measure backscatter from one or more surfaces of the metal element.

28. The method according to claim 1, the method further comprising
providing a laser scanner, the laser scanner being adapted to measure light reflected from one or more surfaces of the metal element.

29. A device configured to cut and at least one shaping and bending a metal element into a final element, the device comprising:
a laser configured to cut and at least one of shape and bend the metal element,
a measuring device configured to measure a position of one or more sections of the metal element being cut and at least one of shaped and bent by the laser,
a controller configured to control the laser, wherein the controller can control at least a vector and velocity of the vector, an amount of energy and beam focus of the laser,
an input/output device adapted to receive and send data, the data comprising at least a final model as to how the metal element is to be processed into the final element by cutting and at least one of shaping and bending, by the laser,
a data processor adapted to process the data from the input/output device and wherein the data processor further calculate at least a first set of instructions to the controller, wherein the first set of instructions comprise at least a sequence of cutting and at least one of shaping and bending and further comprise calculations for the vector and velocity of the vector, the amount of energy and beam focus, to perform a cutting process and at least one of a shaping and bending process, by the laser, to one or more sections of the metal element being at least one of cut, shaped and bent, and
in which the data processor provide at least a secondary set of instructions to the controller, the at least secondary set of instructions being calculated by the data processor based on measurements provided by the measuring device, and in which the device cuts and at least one of shapes and bends the metal element into the final element.

30. The device according to claim 29, the laser further being configured to weld sections of the metal element into the final element.

31. A computer program code adapted to enable a data processor to calculate at least a first set of instructions to a laser device, the laser device comprising at least a first laser, a controller and a measuring device, wherein the computer program code, when being executed by the data processor, is adapted for carrying out the method as set forth in claim 1.
